(19) United States
(12) Patent Application Publication
(10) Pub. No.: US 2003/0127266 A1
(43) Pub. Date: Jul. 10, 2003

(54) Pedal-operated auxilary drive system and method

(75) Inventor: James R. Kirkpatrick, Encino, CA (US)

Correspondence Address: McDERMOTT, WILL & EMERY, 600 13th Street, N.W., Washington, DC, 20005-3096, US

(73) Assignee: Broco International LLC

(21) Appl. No.: 10/038,605

(22) Filed: Jan. 8, 2002

(51) Int. Cl. B62K 11/00

(52) U.S. Cl. 180/205

(57) ABSTRACT

A coupling assembly including an annular ratchet securable to a tire hub, an auxiliary hub rotatably mountable on an axle of the tire hub and having axially extending drive pins, and pawls pivotally mounted on the drive pins. Each pawl has a tooth for contacting teeth of the drive ratchet when free ends of the pawls are pivoted radially outwardly, and an annular pawl linkage is rotatably mountable on the axle and includes bearings circumferentially positioned between the pawls, with each bearing including a link pivotally secured to the free end of one of the pawls. An annular propeller is rotatably mountable on the axle and includes radial projections circumferentially positioned between the pawls, and pins extending axially through the radial projections and received within the bearings of the pawl linkage. A return spring biases the radial projections of the propeller away from the free ends of the pawls.

### FIELD OF THE INVENTION

The present invention relates to a vehicle having an auxiliary drive system and an assembly for coupling the auxiliary drive system to wheels of the vehicle. More particularly, the present invention provides a vehicle having a pedal-operated auxiliary drive system of the type having reciprocating pedals capable of upward and downward movement, wherein the pedal-operated system engages the wheels only when a rotational speed provided to the wheels by the pedals is greater than a rotational speed provided by a primary drive system of the vehicle.

### BACKGROUND OF THE INVENTION

Many power-assisted pedal operated vehicles have been provided. U.S. Pat. No. 4,410,060 to Cunard, for example, shows a power-assisted velocipede (or “moped”) that can be propelled selectively or concurrently by pedal power and by a battery-operated power unit. The velocipede includes a pedal crank that is mechanically coupled to the rear wheel by way of a sprocket incorporating an overrunning clutch, and the power unit is mechanically coupled to the rear wheel by way of a second sprocket also incorporating a one-way clutch. Both clutches are operated so as to permit the rear wheel to overrun in the forward direction.

U.S. Pat. No. 5,242,028 to Murphy et al. shows a motorized bicycle drive system featuring a motor drive with a one-way clutch, a pedal drive with a one-way clutch and a motor driveable sprocket, and a removable interconnecting drive chain for interconnecting the two drives. U.S. Pat. No. 6,276,479 to Suzuki et al. shows a drive arrangement for an electrically power-assisted bicycle, wherein the electrical power assist components are comprised of an electric motor and transmission as one unit and a battery as another unit, with the electric motor and transmission being disposed on one side of and relatively low relative to a manual crank axis and the battery case is disposed on the rear side of the crank axis to improve fore and aft balance while maintaining a low center of gravity.

Pedal-operated vehicles include pedal drive systems for transferring manual power from the operator to the wheels. Reciprocating pedal drives, wherein the pedals are capable of upward and downward movement, are generally preferred over rotary-type pedals drives for example, when it is desirable for an operator to be able to stand during operation of the vehicle.

Various pedal-operated vehicles of the type having reciprocating pedals capable of upward and downward movement have been provided over the years. For example, U.S. Pat. No. 4,828,284 to Sandgren shows a multi-wheeled vehicle powered via a drive train having left and right treadles which, via an interconnected chain and crossover sprockets, drive a rear wheel housing supported stub shaft having a pair of end-mounted, over-running sprocketed clutches, a drive sprocket and a non-reversing clutch. A derailleur-controlled drive chain transfers power from the drive sprocket to the rear wheel.

U.S. Pat. No. 5,368,321 to Berman et al. shows a vehicle having a pair of reciprocating pedals (described as “footboards”) and a drive mechanism which cross-couples the pedals together, whereby downward displacement of either pedal causes an equal and upward displacement of the other pedal. The Berman vehicle also includes a pair of sprockets coupled to a drive shaft by means of “unidirectional” one-way clutches that substantially prevent backward movement of the vehicle.

U.S. Pat. No. 6,173,981 to Coleman shows a pedal-operated vehicle including first and second independently operable pedals reciprocatingly mounted to the vehicle so as to be capable of upward and downward movement. A drive mechanism can be selectively placed in an engaged mode or a disengaged mode. In the engaged mode, downward movement of either pedal imparts torque to a wheel in a first direction of rotation to propel the vehicle forward, and upward movement of either pedal imparts no torque to the rear wheel. The wheel is nonrotatable in a second direction of rotation in the engaged mode. In the disengaged mode, the wheel is freely rotatable in both the second and the first direction of rotations.

What is desired is a wheeled vehicle having an engine-powered primary drive system, a pedal-operated auxiliary drive system, and an assembly for coupling the auxiliary drive system to wheels of the vehicle upon sufficient application of manual power to the pedals. Preferably, the assembly will allow the auxiliary drive system to engage the wheels only when a rotational speed provided to the wheels by the pedals is greater than a rotational speed provided by the primary drive system. Otherwise, the coupling assembly will allow the wheels to rotate forward and backwards independently of the pedal-operated auxiliary drive system. In addition, the pedal-operated auxiliary drive system will preferably be of the type having reciprocating pedals capable of upward and downward movement. Furthermore, it is preferred that the reciprocating pedals be independently operable.

### SUMMARY OF THE INVENTION

The present invention, therefore, provides a vehicle including an axle, a tire hub rotatably mounted on the axle, a primary drive system for turning the tire hub, an auxiliary drive system, and a coupling assembly for coupling the auxiliary drive system to the tire hub.

The primary drive system includes a primary driven wheel secured to the tire hub for rotation therewith. The coupling assembly includes an annular ratchet secured to the tire hub for rotation therewith, coaxial with the axle, and the ratchet includes teeth extending radially inwardly with respect to the axle.

The coupling assembly also includes a sleeve rotatably mounted on the axle, an auxiliary hub coaxially secured on the sleeve and having axially extending drive pins, and a pawl pivotally mounted on each of the drive pins of the auxiliary hub coaxially within the annular ratchet. Each pawl has a tooth extending radially outwardly with respect to the axle for contacting the teeth of the drive ratchet when free ends of the pawls extend radially outwardly. An annular pawl linkage is rotatably mounted on the sleeve coaxially within the pawls and having bearings circumferentially positioned between the pawls, with each bearing having a link pivotally secured to the free end of one of the pawls. An annular propeller is coaxially secured on the sleeve within the pawls and including radial projections circumferentially positioned between the pawls, and pins extending axially through the radial projections and received within the bearings of the pawl linkage.

At least one return spring biases the radial projections of the propeller away from the free ends of the pawls, whereby the free ends are normally draw radially inwardly with respect to the axle such that the teeth of the pawls are not in contact with the teeth of the drive ratchet. The auxiliary drive system includes an auxiliary driven wheel coaxially secured on the sleeve of the coupling assembly, and the return spring is sized such that the free ends of the pawls are allowed to extend radially outwardly upon application of at least a predetermined amount of torque to the auxiliary driven wheel in a predetermined direction of rotation.

According to one aspect of the present invention, the predetermined direction of rotation comprises forward rotation. According to another aspect, the teeth of the ratchet and the teeth of the pawls are adapted and arranged such that the teeth of the pawls only engage the teeth of the ratchet when a rotational speed of the auxiliary hub in the predetermined direction of rotation is greater than a rotational speed of the annular ratchet in the predetermined direction of rotation. According to a further aspect, the teeth of the ratchet each include an engagement surface facing against the predetermined direction of rotation, and the teeth of the pawls each include an engagement surface facing towards the predetermined direction of rotation. According to an additional aspect, the teeth of the ratchet each include a disengagement surface facing towards the predetermined direction of rotation, and the teeth of the pawls each include a disengagement surface facing against the predetermined direction of rotation.

The presently disclosed coupling assembly provides many benefits including allowing wheels of the vehicle to rotate forward and backwards independently of the auxiliary drive system. In addition, the auxiliary drive system can be activated at any speed. If the vehicle is traveling at a speed greater than the auxiliary drive system can provide, then the coupling assembly does not couple the auxiliary drive system to the wheels.

The present invention also provides a drive system having an independently operable, reciprocating pedal for turning a tire hub of a vehicle. The system includes a driven wheel rotatably mountable on an axle of the vehicle and adapted to be coupled to the tire hub, an idler wheel rotably mountable on a frame of the vehicle, and an endless linkage extending between the idler wheel and the driven wheel. A clamp is secured to the endless linkage between the idler wheel and the driven wheel, and a member has a distal end pivotally connected to the clamp and a proximal end pivotably securably to the frame of the vehicle. The system also includes a pedal linkage having a proximal end pivotably securably to the frame of the vehicle, the pedal linkage connected to the member such that pivotal movement of the pedal linkage about the proximal end of the pedal linkage causes pivotal movement of the member about the proximal end of the member, and a pedal pivotally connected to a distal end of the pedal linkage.

The foregoing and other features, aspects and advantages of the present invention will become more apparent from the following detailed description of the present invention when taken in conjunction with the accompanying drawings.

### BRIEF DESCRIPTION OF THE DRAWINGS

FIG. 1 is a rear perspective view of a representative embodiment of a vehicle constructed in accordance with the present invention, wherein exterior body panels of the vehicle have been removed;

FIG. 2 is a top perspective view of the vehicle of FIG. 1;

FIG. 3 is a rear perspective view of portions of exemplary embodiments of motor-powered “primary” drive systems and pedal-powered “auxiliary” drive systems of the vehicle of FIG. 1;

FIG. 4 is an exploded and enlarged rear perspective view of an exemplary embodiment of a coupling assembly of the vehicle of FIG. 1, for coupling one of the pedal-powered drive systems to a tire hub of the vehicle;

FIG. 5 is a further enlarged, exploded rear perspective view of the coupling assembly of the vehicle of FIG. 1;

FIG. 6 is an enlarged end elevation view of the coupling assembly of the vehicle of FIG. 1, wherein exemplary embodiments of pawls of the assembly are shown disengaged from an exemplary embodiment of a ratchet of the assembly;

FIG. 7 is an enlarged end elevation view of the annular ratchet and the pawl assembly of the pedal-powered drive system of the vehicle of FIG. 1, wherein the pawls are shown engaged with the ratchet;

FIG. 8 is an enlarged side elevation view of one of the exemplary embodiments of the pedal-powered “auxiliary” drive systems of the vehicle of FIG. 1, with a pedal shown in an “up” position; and

FIG. 9 is a side perspective view of exemplary embodiments of a telescoping member and a pedal linkage of the pedal-powered “auxiliary” drive systems of the vehicle of FIG. 1.

Like reference characters designate identical or corresponding components and units throughout the various figures.

### DETAILED DESCRIPTION OF AN EXEMPLARY EMBODIMENT

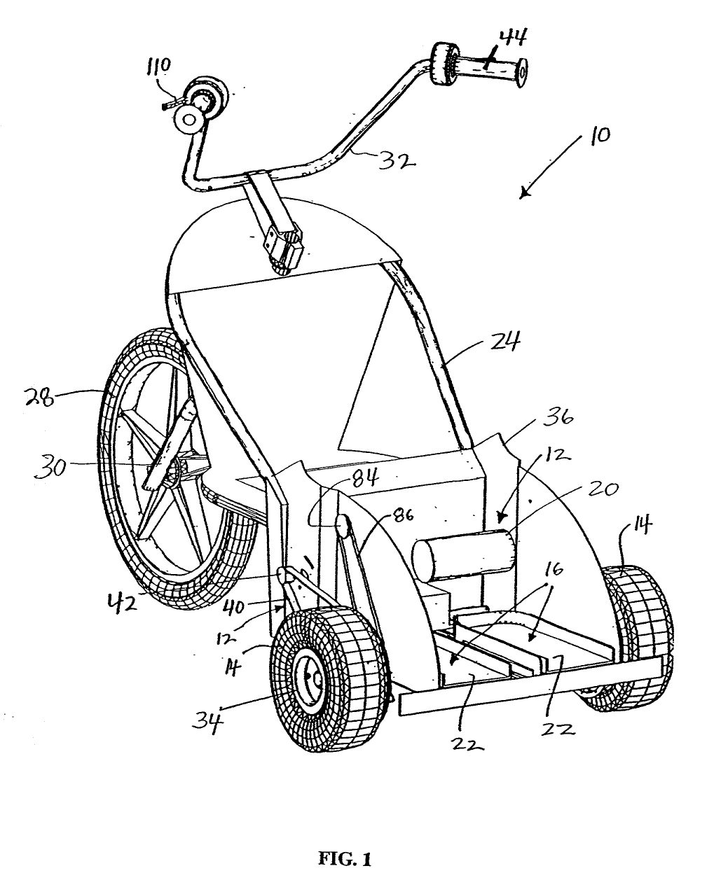

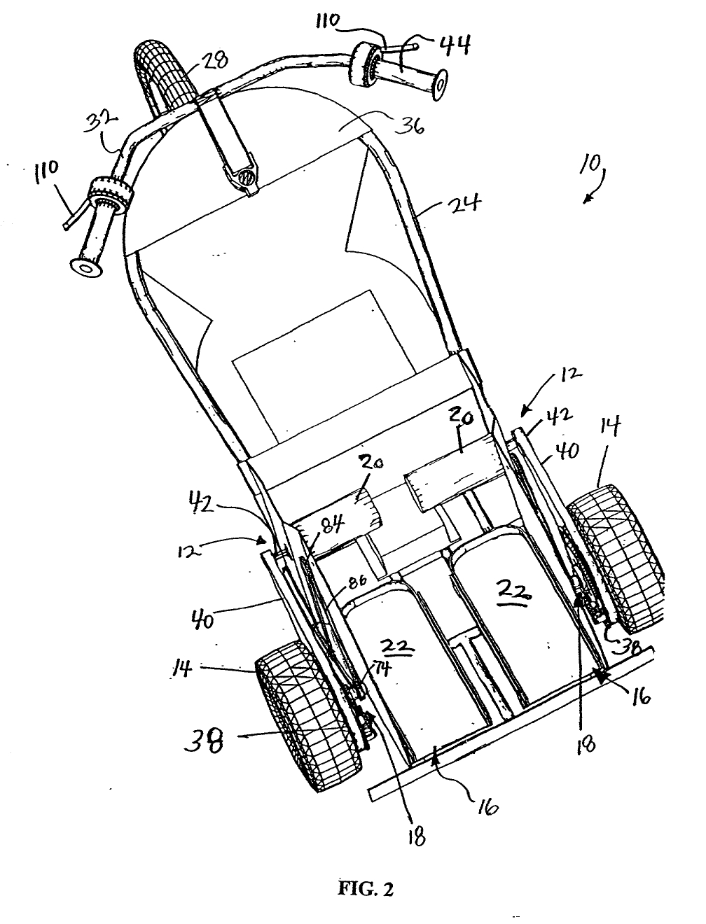

Referring to FIGS. 1 and 2, an exemplary embodiment of the present invention generally comprises a vehicle 10 having primary drive systems 12 for turning drive tires 14 of the vehicle, auxiliary drive systems 16, and coupling assemblies 18 for coupling the auxiliary drive systems 16 to the tires 14. The coupling assemblies 18 of the present invention provide many benefits including, but not limited to, allowing the tires 14 to freely rotate forward and backwards with respect to the auxiliary drive systems 16 when the auxiliary drive systems are not in use. In addition, the coupling assemblies 18 allow the auxiliary drive systems 16 to be activated at any speed (e.g., in a “forward” direction). If the vehicle 10 is traveling at a speed greater than the auxiliary drive systems 16 can provide, then the coupling assemblies 18 do not couple the auxiliary drive systems to the tires 14.

The auxiliary drive systems 16 of the present invention also provide many benefits including, but not limited to, allowing independent operation by a vehicle rider of each auxiliary drive system 16. In addition, the auxiliary drive systems 16 allow the rider to stand while operating the vehicle 10 and to more easily balance the vehicle during operation.

In the exemplary embodiment of the invention shown, each of the primary drive systems 12 includes an electric motor 20, while each of the auxiliary drive systems 16 is powered by a novel and unique assembly of an independently operable, reciprocating pedal 22 that can be manually operated by a rider standing on the pedals 22 while steering the vehicle 10. Each pedal 22 is provided with one of the coupling assemblies 18 for coupling the pedal to one of the drive wheels 14.

The vehicle 10 is preferably similar to a single person, three-wheeled, electrically powered, “American Chariot” vehicle available from the American Chariot Company, Inc. of Van Nuys, Calif. The vehicle 10 constructed in accordance with the present invention, however, further includes the herein disclosed and claimed auxiliary drive systems 16 and the herein disclosed and claimed coupling assemblies 18.

It should be understood, however, that a vehicle constructed in accordance with the present invention can include a primary drive system including a motor(s) other than an electric motor, such as an internal combustion engine. A vehicle constructed in accordance with the present invention can also include a primary drive system 12 and coupling assemblies 18 as disclosed herein, and an auxiliary drive system, wherein the auxiliary drive system comprises something other than the independently operable, reciprocating pedals disclosed herein. For example, a vehicle constructed in accordance with the present invention can be provided with a single auxiliary drive system having dependently operable, reciprocating pedals or rotary driven pedals instead of the independently operable, reciprocating pedals disclosed herein.

In addition, a vehicle constructed in accordance with the present invention can be provided with an auxiliary drive system having a relatively small electric or internal combustion engine instead of the independently operable, reciprocating pedals disclosed herein (for example, the primary drive system might comprise an internal combustion engine for outdoor use while the auxiliary drive system comprises an electric motor for indoor use). In any event, many variations of a vehicle constructed in accordance with the present invention are possible. The present invention is also intended to cover a vehicle having just a drive system 16 having independently operable, reciprocating pedals 22 as disclosed herein, without the primary drive system or the coupling assembly.

Vehicle Frame and Body

As shown best in FIGS. 1 and 2, the exemplary embodiment of a vehicle 10 constructed in accordance with the present invention includes a metal tubular frame 24 having three wheels mounted for rotation on the frame 24: the two rear, driven wheels 14 mounted on an axle 26 secured to the frame 24, and one front, steered wheel 28 secure to a fork 30 extending from a handle bar 32 pivotally secured to the frame 24. Each rear wheel 14 includes tire hubs 34 rotatably mounted on the axle 26. The vehicle 10 also includes body panels 36 secured to the frame 24. Many of the exterior body panels and fenders are removed in FIGS. 1 and 2 to provide views of the interior features of the vehicle 10, but preferred ornamental designs for the presently disclosed vehicle 10 are shown in U.S. design Pat. Nos. 427,945 and 428,364, which are incorporated herein by reference. Although not discussed herein, it is intended that the vehicle 10 will also include other features common in similar vehicles, such as brakes and lights.

Primary Drive Systems

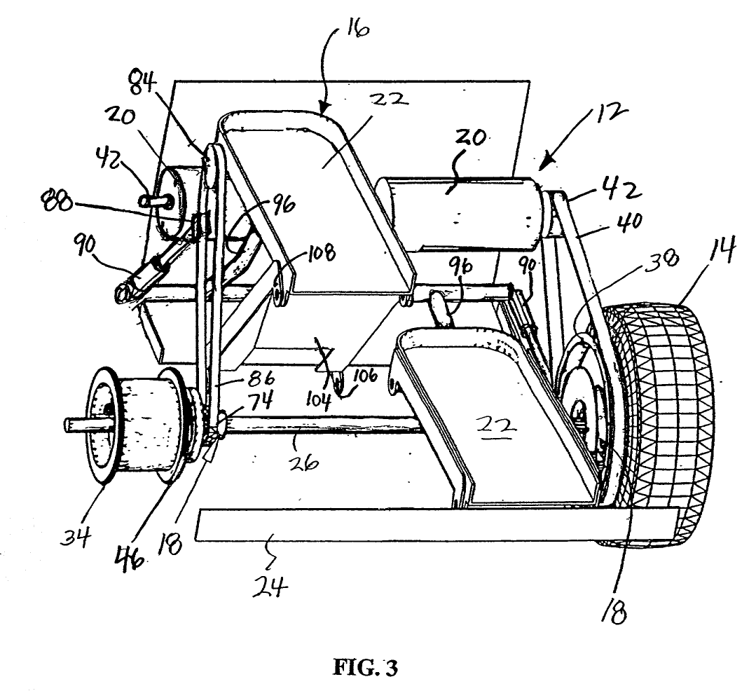

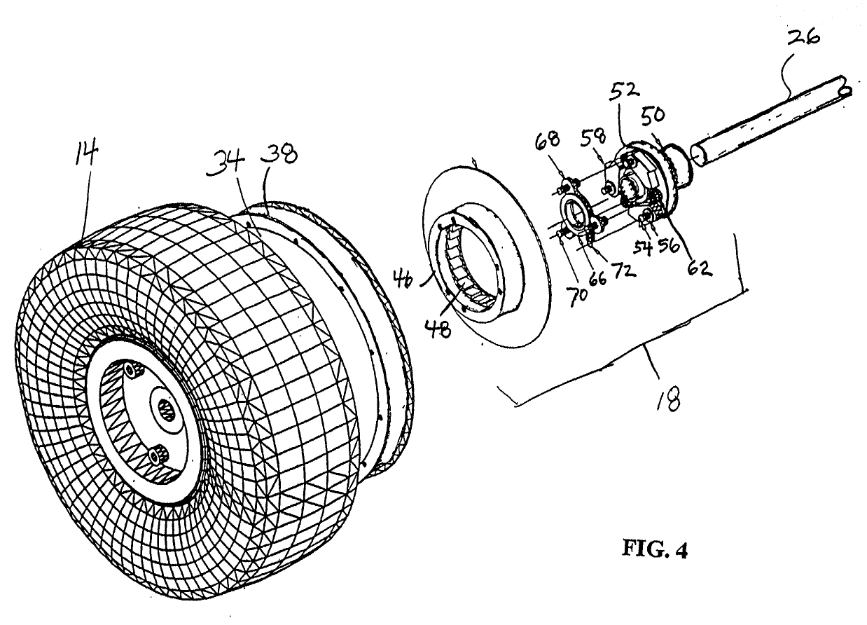

As also shown in FIGS. 3 and 4, each exemplary embodiment of a primary drive system 12 constructed in accordance with the present invention includes primary driven wheels 38 secured to the rear tire hubs 34, and synchronized endless linkages 40 extending between drive wheels 42 of the motors 20 and the primary driven wheels 38 for turning the rear tires 14 in either forward or reverse directions upon actuation of the motors 20. Preferably, the drive and the driven wheels comprise pulleys 42, 38 and the endless linkage comprises a belt 40, although a chain and sprockets can alternatively be used.

Each of the primary drive systems 12 in the exemplary embodiment includes a one-half horsepower, twenty-four volt, permanent magnet, sealed-bearing motors 20. Although not shown, the primary drive systems 12 also each include a power source for providing power to the electric motors 20 and an electronic motor controller. Preferably, the electronic motor controller is a programmable, microprocessor controlled MOSFET PWM with thermal protection and forward and reverse modes, and the power source comprises two twelve volt, zero maintenance sealed gel cell modules providing a total of twenty-four volts. The primary drive system 12 also includes a charger, which preferably comprises a twenty-four volt, automatic, level three rapid charger. A throttle 44 is provided on the handle bar 32 of the vehicle 10 and connected to the electronic motor controller for allowing a rider to control the speed of the electric motors 20 of the primary drive systems 12.

Coupling Assemblies

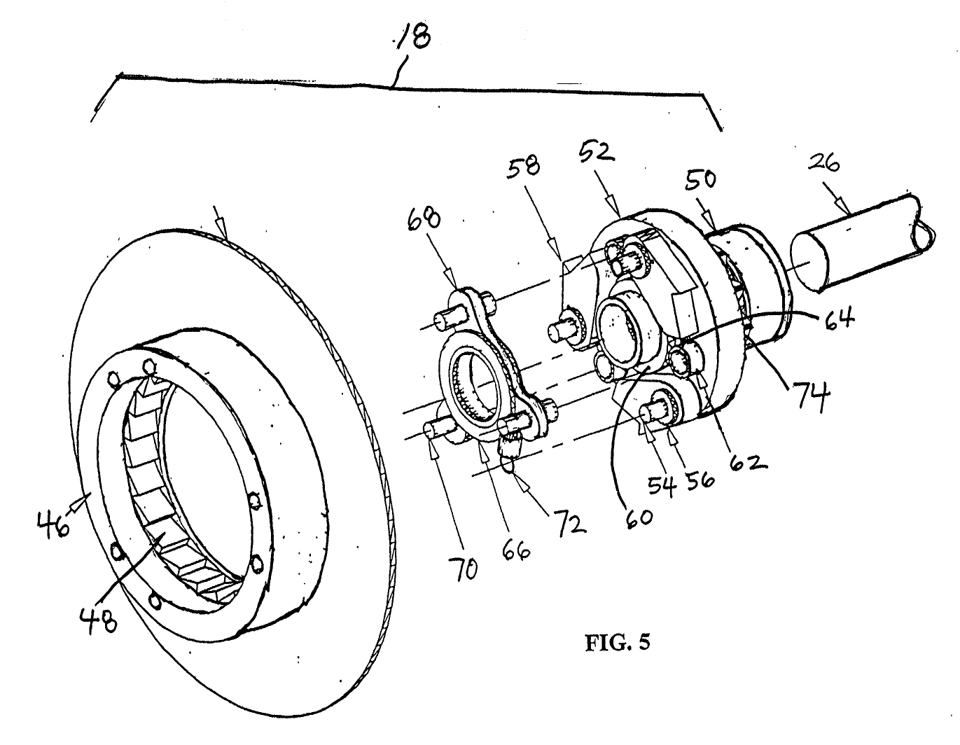

Referring to FIGS. 4 through 7, the exemplary embodiments of coupling assemblies 18 constructed in accordance with the present invention each include an annular ratchet 46 secured to the tire hub 34 for rotation therewith, coaxial with the axle 26, and the ratchet 46 includes teeth 48 extending radially inwardly with respect to the axle 26. A sleeve 50 is rotatably mounted on the axle 26, an auxiliary hub 52 is coaxially secured on the sleeve 50 and has axially extending drive pins 54, and a pawl 56 is pivotally mounted on each of the drive pins 54 coaxially within the annular ratchet 46.

Each pawl 56 has a tooth 58 extending radially outwardly with respect to the axle 26 for contacting the teeth 48 of the drive ratchet 46 when free ends of the pawls 56 extend radially outwardly. An annular pawl linkage 60 is rotatably mounted on the sleeve 50 coaxially within the pawls 56 and has bearings 62 circumferentially positioned between the pawls 56, with each bearing having a link 64 pivotally secured to the free end of one of the pawls 56. An annular propeller 66 is coaxially secured on the sleeve 50 within the pawls 56 and includes radial projections 68 circumferentially positioned between the pawls 56, and pins 70 extending axially through the radial projections 68 and received within the bearings 62 of the pawl linkage 60.

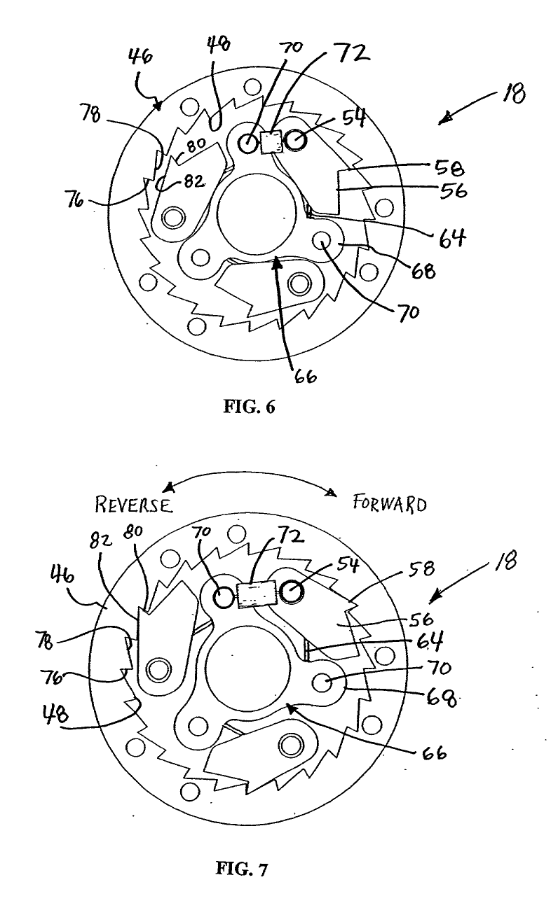

The coupling assembly 18 also includes at least one return spring 72 biasing the radial projections 68 of the propeller 66 away from the free ends of the pawls 56, whereby the free ends are normally draw radially inwardly with respect to the axle 26 such that the teeth 58 of the pawls 56 are not in contact with the teeth 48 of the drive ratchet 46, as shown in FIG. 6. In the embodiment shown, the return spring 72 is connected between one of the pins 54 of the auxiliary hub and one of the pins 70 of the propeller and biases the two pins 54, 70 together. The coupling assembly 18 allows the ratchet 46, and thus the tire hub 34, to rotate in forward and reverse directions when the teeth 58 of the pawls 56 are not in contact with the teeth 48 of the drive ratchet 46.

The auxiliary drive system 16 includes an auxiliary driven wheel 74 coaxially secured on the sleeve 50 of the coupling assembly 18, and the return spring 72 is sized such that the free ends of the pawls 56 are allowed to extend radially outwardly, as shown in FIG. 7, upon application of at least a predetermined amount of torque to the auxiliary driven wheel 74 in a predetermined direction of rotation. In the exemplary embodiment, the predetermined direction of rotation comprises forward rotation, as shown in FIG. 7. Preferably, the predetermined amount of torque is great enough to allow a rider to slowly move the pedals 22 through their full range of motion without causing the coupling assembly 18 to engage the tire hubs 34. Yet the predetermined amount of torque is preferably low enough to cause the coupling assembly 18 to engage the tire hubs 34 upon the rider more quickly moving the pedals 22 through their fill range of motion.

The teeth 48 of the ratchet 46 and the teeth 58 of the pawls 56 are adapted and arranged such that the teeth 58 of the pawls 56 only engage the teeth 48 of the ratchet 46 when a rotational speed of the auxiliary hub 52 in the forward direction of rotation is greater than a rotational speed of the annular ratchet 46 in the forward direction of rotation (and the pawls 56 are pivoted radially outward). Referring in particular to FIGS. 6 and 7, in the exemplary embodiment the teeth 48 of the ratchet 46 each include an engagement surface 76 facing against the forward direction of rotation, and the teeth 58 of the pawls 56 each include an engagement surface 80 facing towards the forward direction of rotation. Thus, when the rotational speed of the annular ratchet 46 is less than the rotational speed of the auxiliary hub 52 in the forward direction of rotation, the engagement surfaces 76, 80 of the teeth 48, 58 cause the teeth 58 of the pawls 56 to engage the teeth 48 of the ratchet 46.

In addition, in the exemplary embodiment the teeth 48 of the ratchet 46 each include a disengagement surface 78 facing towards the forward direction of rotation, and the teeth 58 of the pawls 56 each include a disengagement surface 82 facing against the forward direction of rotation. Thus, when the rotational speed of the annular ratchet 46 is greater than the rotational speed of the auxiliary hub 52 in the forward direction of rotation, the disengagement surfaces 78, 82 of the teeth 48, 58 cause the teeth 48 of the ratchet 46 to disengage, or slide over, the teeth 58 of the pawls 56.

Auxiliary Drive Systems

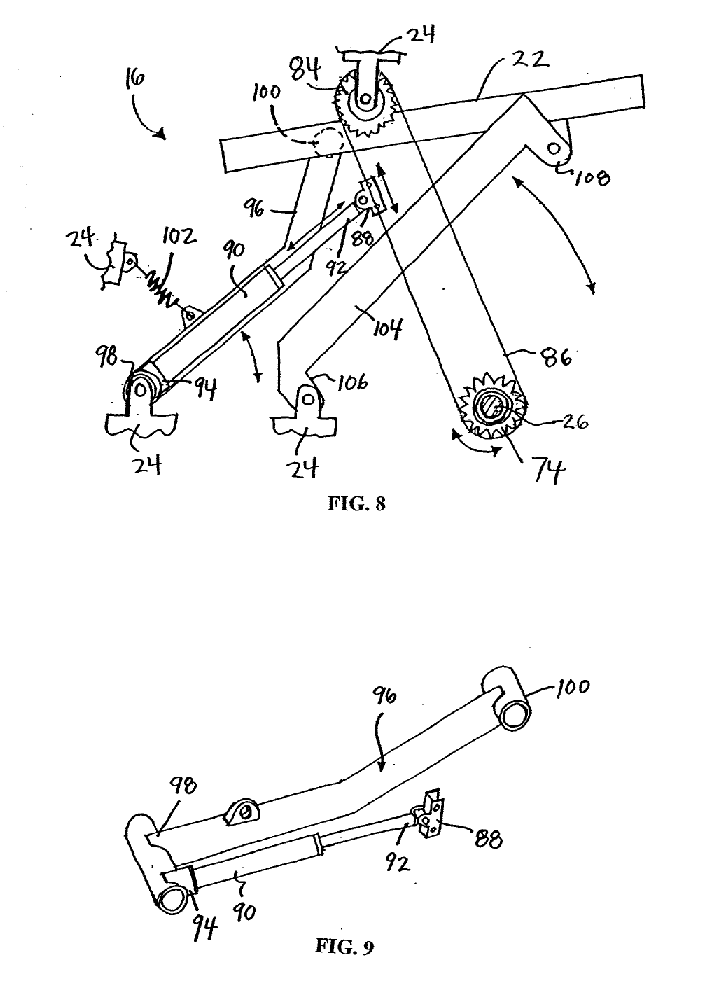

Referring in particular to FIGS. 3 and 8, the exemplary embodiments of independently operable, pedal-powered auxiliary drive systems 16 of the present invention each include a reciprocating pedal 22 capable of independent upward and downward movement. Each system 16 also includes the driven wheel 74 rotatably mounted on the sleeve 50 of the coupling assembly 18 for coupling to the tire hub 34, an idler wheel 84 rotably mounted on the frame 24 of the vehicle 10, and an endless linkage 86 extending between the idler wheel 84 and the driven wheel 74. Preferably, the idler and the driven wheels comprise sprockets 84, 74 and the endless linkage comprises a chain 86, although a belt and pulleys can alternatively be used.

A clamp 88 is secured to the endless linkage 86 between the idler and the driven wheels 84, 74, and a member 90 has a distal end 92 pivotally connected to the clamp 88 and a proximal end 94 pivotably secured to the frame 24 of the vehicle 10. The system 16 also includes a first pedal linkage 96 having a proximal end 98 pivotably secured to the frame 24 of the vehicle 10, with the pedal linkage 96 connected to the member 90, as also shown in FIG. 9, such that pivotal movement of the pedal linkage 96 about the proximal end 98 causes pivotal movement of the member 90 about the proximal end 94 of the member 90. The pedal 22 is pivotally connected to a distal end 100 of the pedal linkage 96.

In the exemplary embodiment shown, the member 90 has length between the distal end 92 and the proximal end 94 that varies so that the distal end 92 of the member 90 is able to follow the travel path of the endless linkage 84 as the member moves the clamp 88, and thus the endless linkage 84, up and down with respect to the drive sprocket 74. Alternative to a member 90 having a variable length, the drive system 16 can be provided with a non-variable length member in place of the variable length member 90 and a tensioning mechanism (not shown) for maintaining the endless linkage 84 in tension while the non-variable length member pivots up and down. Preferably, the variable length member is provided in the form of a “telescoping” member 90.

A pedal spring 102 extends between the frame 24 of the vehicle 10 and the pedal linkage 96 and acts to bias the pedal 22 upwardly. The system 16 also has a second pedal linkage 104 having a proximal end 106 pivotably secured to the frame 24 of the vehicle 10 and a distal end 108 pivotally connected to the pedal 22.

The rider assumes a standing position on the vehicle 10 and can operate the pedals 22 independently of one another. Upon pressing the pedal 22 downward in a down stroke, the telescoping member 90 pivots downward, and extends and then retracts as the clamp 88 is moved towards the driven sprocket 74, such that the chain 86 is moved towards the driven sprocket 74. When downward pressure upon the pedal 22 is relieved, the pedal 22 returns upwardly because of the upward biasing action of the pedal spring 102. In an up stroke, the telescoping member 90 pivots upward and extends and then retracts as the clamp 88 is moved towards the idler sprocket 84, such that the chain 86 is moved towards the idler sprocket 84.

The one-way action of the coupling assembly 18 causes rotation of the auxiliary driven wheel 74 in the first direction of rotation (e.g., forward direction) to impart torque to the ratchet 46 in the first direction of rotation, but does not transfer torque to the ratchet 46 upon rotation of the sprocket 74 in the second direction of rotation (e.g., reverse direction). Thus, downward movement of the pedal 22 imparts torque to the rear wheel 14 in the first direction of rotation to propel the vehicle 10 forward. Upward movement of the pedal 22 imparts no torque to the rear wheels 14 because no torque is imparted through the coupling assembly 18. If preferred, after having propelled the vehicle 10 forward at a desired speed, the rider can simply “coast” forwardly by standing on one or both pedals 22.

The vehicle 10 also preferably includes mechanisms (not shown) for maintaining the pedals 22 in their lowered positions as shown in FIGS. 1 and 2. As also shown in FIGS. 1 and 2, levers 110 are provided on the handle bar 32 for releasing the mechanisms and freeing the pedals 22 for use by a rider. Otherwise, a rider can simply stand on the lowered pedals 22 and “coast” on the vehicle.

The present invention, therefore, provides a vehicle 10 including an axle 26, tire hubs 34 rotatably mounted on the axle 26, primary drive systems 12 for turning the tire hub 34, auxiliary drive systems 16, and coupling assemblies 18 for coupling the auxiliary drive systems 16 to the tire hubs 34 only when the auxiliary drive systems 16 provide a greater rotational speed to the tire hubs 34 than the primary drive systems 12.

Although the present invention has been described in detail, it is to be understood that the description is provided only for illustration and example and is not meant to be limiting. The scope of the present invention is limited only by the terms of the appended claims.

What is claimed is:

1. A coupling assembly for coupling an auxiliary drive system to a tire hub rotatably mounted of an axle of a vehicle, comprising:
an annular ratchet securable to the tire hub for rotation with the tire hub about the axle, the ratchet including teeth extending radially inwardly;
an auxiliary hub rotatably mountable on the axle and having axially extending drive pins, the auxiliary hub connectable to an auxiliary driven wheel;
a pawl pivotally mounted on each of the drive pins of the auxiliary hub, each pawl having a tooth extending radially outwardly for contacting the teeth of the drive ratchet when free ends of the pawls are pivoted radially outwardly;
an annular pawl linkage rotatably mountable on the axle and including bearings circumferentially positioned between the pawls, each bearing including a link pivotally secured to the free end of one of the pawls;
an annular propeller rotatably mountable on the axle and including radial projections, and pins extending axially through the radial projections and received within the bearings of the pawl linkage; and
at least one return spring biasing the radial projections of the propeller away from the free ends of the pawls, whereby the free ends are normally pivoted radially inwardly such that the teeth of the pawls are not in contact with the teeth of the drive ratchet;
wherein the return spring is sized such that the free ends of the pawls are allowed to pivot radially outwardly upon at least a predetermined amount of torque applied to the auxiliary hub in a predetermined direction of rotation.

2. A coupling assembly according to claim 1, wherein the predetermined direction of rotation comprises a forward direction of rotation.

3. A coupling assembly according to claim 1, wherein the teeth of the ratchet and the teeth of the pawls are adapted and arranged such that the teeth of the pawls only engage the teeth of the ratchet when a rotational speed of the auxiliary hub in the predetermined direction of rotation is greater than a rotational speed of the annular ratchet in the predetermined direction of rotation.

4. A coupling assembly according to claim 3, wherein the teeth of the ratchet each include an engagement surface facing against the predetermined direction of rotation and the teeth of the pawls each include an engagement surface facing towards the predetermined direction of rotation.

5. A coupling assembly according to claim 4, wherein the teeth of the ratchet each include a disengagement surface facing towards the predetermined direction of rotation and the teeth of the pawls each include a disengagement surface facing against the predetermined direction of rotation.

6. A coupling assembly according to claim 1, wherein the return spring is connected between one of the pins of the auxiliary hub and one of the pins of the propeller and biases said pins together.

7. A coupling assembly according to claim 1, further comprising an auxiliary wheel connected to the auxiliary hub.

8. A coupling assembly according to claim 7, wherein the auxiliary wheel comprises a driven sprocket.

9. A vehicle including a coupling assembly according to claim 1, and further comprising:
an axle;
a tire hub rotatably mounted on the axle with the annular ratchet of the coupling assembly secured to the tire hub for rotation therewith, coaxial with the axle;
a sleeve rotatably mounted on the axle, with the auxiliary wheel coaxially secured on the sleeve, the auxiliary hub coaxially secured on the sleeve such that the pawls pivotally mounted thereon are coaxially within the annular ratchet, the annular pawl linkage rotatably mounted on the sleeve coaxially within the pawls, and the annular propeller rotatably mounted on the sleeve coaxially within the pawls.

10. A vehicle according to claim 9, further comprising a primary drive system including:
a primary driven wheel secure to the tire hub;
a primary drive wheel;
a motor operatively arranged to turn the primary drive wheel when actuated; and
an endless linkage extending between the primary drive wheel and the primary driven wheel.

11. A vehicle according to claim 10, wherein the endless linkage comprises a belt and the primary drive and driven wheels comprise pulley wheels.

12. A vehicle according to claim 10, wherein the motor comprises an electric motor.

13. A vehicle according to claim 12, wherein the primary drive system further comprises a rechargeable electrical power source connected to the electrical motor.

14. A vehicle according to claim 9, further comprising an auxiliary drive system including:
an auxiliary driven wheel secured to the sleeve of the coupling assembly;
an auxiliary idler wheel rotatably secured to a frame of the vehicle; and
an endless linkage extending between the auxiliary idler wheel and the auxiliary driven wheel.

15. A vehicle according to claim 14, wherein the endless linkage of the auxiliary drive system comprises a chain and the auxiliary idler and driven wheels comprise sprocket wheels.

16. A vehicle according to claim 14, wherein the auxiliary drive system further includes a pedal operatively arranged to move the endless linkage and turn the auxiliary driven wheel when the pedal is manually operated by a rider of the vehicle.

17. A vehicle according to claim 16, wherein the pedal comprises a reciprocating pedals capable of upward and downward movement.

18. A vehicle according to claim 16, wherein the pedal is adapted to cause reciprocating movement of the endless linkage upon operation by a rider.

19. A vehicle according to claim 16, wherein the pedal is biased away from the auxiliary driven wheel.

20. A drive system for turning a tire hub rotatably mounted on an axle of a vehicle, comprising:
a driven wheel rotatably mountable on the axle and adapted to be coupled to the tire hub;
an idler wheel rotably mountable on a frame of the vehicle;
an endless linkage extending between the idler wheel and the driven wheel;
a clamp secured to the endless linkage between the idler wheel and the driven wheel;
a member having a distal end pivotally connected to the clamp and a proximal end pivotably securably to the frame of the vehicle;
a pedal linkage having a proximal end pivotably securably to the frame of the vehicle, the pedal linkage connected to the member such that pivotal movement of the pedal linkage about the proximal end of the pedal linkage causes pivotal movement of the member about the proximal end of the member; and
a pedal pivotally connected to a distal end of the pedal linkage.

21. A drive system according to claim 20, further comprising a spring for extending between the frame of the vehicle and the pedal linkage.

22. A drive system according to claim 20, further comprising a second pedal linkage having a proximal end pivotably securably to a frame of the vehicle and a distal end pivotally connected to the pedal.

23. A drive system according to claim 20, wherein the endless linkage comprises a chain and the idler and the driven wheels comprise sprocket wheels.

24. A vehicle including a coupling assembly according to claim 20, and further comprising:
a frame, with the idler wheel rotably mounted on the frame, the proximal end of the member pivotably secured to the frame, and the proximal end of the pedal linkage pivotably secured to the frame;
an axle secured to the frame, with the driven wheel rotatably mounted on the axle; and
a tire hub rotatably mounted on the axle.

25. A vehicle according to claim 24, further comprising a primary drive system including:
a primary driven wheel secure to the tire hub;
a primary drive wheel;
a motor operatively arranged to turn the primary drive wheel when actuated; and
an endless linkage extending between the primary drive wheel and the primary driven wheel.

26. A vehicle according to claim 25, wherein the endless linkage comprises a belt and the primary drive and driven wheels comprise pulley wheels.

27. A vehicle according to claim 25, wherein the motor comprises an electric motor.

28. A vehicle according to claim 25, wherein the primary drive system further comprises a rechargeable electrical power source connected to the electrical motor.

29. A vehicle according to claim 24, further including a coupling assembly for coupling the driven wheel to the tire hub, comprising:
an annular ratchet secured to the tire hub for rotation with the tire hub about the axle, the ratchet including teeth extending radially inwardly;
an auxiliary hub rotatably mounted on the axle and having axially extending drive pins, the auxiliary hub connected to the driven wheel such that turning the driven wheel turns the auxiliary hub;
a pawl pivotally mounted on each of the drive pins of the auxiliary hub, each pawl having a tooth extending radially outwardly for contacting the teeth of the drive ratchet when free ends of the pawls are pivoted radially outwardly;
an annular pawl linkage rotatably mountable on the axle and including bearings circumferentially positioned between the pawls, each bearing including a link pivotally secured to the free end of one of the pawls;
an annular propeller rotatably mountable on the axle and including radial projections circumferentially positioned between the pawls, and pins extending axially through the radial projections and received within the bearings of the pawl linkage; and
at least one return spring biasing the radial projections of the propeller away from the free ends of the pawls, whereby the free ends are normally pivoted radially inwardly such that the teeth of the pawls are not in contact with the teeth of the drive ratchet;
wherein the return spring is sized such that the free ends of the pawls are allowed to pivot radially outwardly upon at least a predetermined amount of torque applied to the driven wheel in a predetermined direction of rotation.

30. A vehicle according to claim 29, wherein the predetermined direction of rotation comprises a forward direction of rotation.

31. A vehicle according to claim 29, wherein the teeth of the ratchet and the teeth of the pawls are adapted and arranged such that the teeth of the pawls only engage the teeth of the ratchet when a rotational speed of the auxiliary hub in the predetermined direction of rotation is greater than a rotational speed of the annular ratchet in the predetermined direction of rotation.

32. A vehicle according to claim 31, wherein the teeth of the ratchet each include an engagement surface facing against the predetermined direction of rotation and the teeth of the pawls each include an engagement surface facing towards the predetermined direction of rotation.

33. A vehicle according to claim 32, wherein the teeth of the ratchet each include a disengagement surface facing towards the predetermined direction of rotation and the teeth of the pawls each include a disengagement surface facing against the predetermined direction of rotation.

34. A vehicle according to claim 29, wherein the return spring comprise is connected between one of the pins of the auxiliary hub and one of the pins of the propeller and biases said pins together.

35. A drive system according to claim 20, wherein a length between the proximal and the distal ends of the member is variable.

36. A drive system according to claim 35, wherein the member comprises a telescoping member.
